(19) United States
(12) Patent Application Publication
(10) Pub. No.: US 2020/0256115 A1
(43) Pub. Date: Aug. 13, 2020

(54) Garage Door Window

(71) Applicant: James A. Vitello, Escondido, CA (US)

(72) Inventor: James A. Vitello, Escondido, CA (US)

(21) Appl. No.: 16/441,860

(22) Filed: Jun. 14, 2019

Related U.S. Application Data
(63) Continuation-in-part of application No. 16/274,001, filed on Feb. 12, 2019.

(51) Int. Cl. E06B 3/58; E06B 3/62

(52) U.S. Cl. CPC E06B 3/5892; E06B 2003/7044; E06B 3/62

(57) ABSTRACT

This invention is directed toward a window for a garage door panel, where the window has an interior frame and an exterior frame. Both the interior and exterior frame have straight members that are secured to each other through the parts of the garage door that surround the opening with screws and screw receptacles. Connecting the frame members are corner braces, than come in a variety of designs, with some being invisible after installation and others forming a decorative “corner” to the window.

### CROSS REFERENCE TO RELATED APPLICATIONS

This application is a continuation-in-part from U.S. Utility patent application Ser. No. 16/274,001, entitled Garage Door Window, filed 12 Feb. 2019, the contents of which are incorporated by reference.

### STATEMENT REGARDING FEDERALLY SPONSORED RESEARCH OR DEVELOPMENT

This invention was not federally sponsored.
INVENTOR: James Vitello, citizen of US.
Attorney Docket: JimV-CIP

### BACKGROUND OF THE INVENTION

Field of the invention: This invention relates to the general field of garage doors, and more specifically to a window designed for a panel of a garage door.

History of the invention. Garage doors have been in existence for since Roman times, but as pertaining to the automobile industry began in the early 1900′s, beginning as monolithic, single panel garage doors. Over the past several decades, sectional garage doors have become more and more popular as they can be “rolled” up in sections, thereby not requiring any “swing distance” away from the garage to swing as they are pulled up. A second advantage of sectional, or panel, garage doors is that each section or panel has a connection to track upon which it slides, thereby giving the door a more secure means of attachment to the garage door than would a traditional, monolithic garage door, which is usually connected to the garage door through two springs.

An ongoing problem with garage doors is that the common materials from which they are made—namely metal, plastic and wood—do not tend to “breath” well. Garages are notorious for storing a wide variety of smelly and toxic articles, ranging from the gasoline-powered engines of automobiles and lawnmowers to paint and other chemicals. While some monolithic garage doors had glass windows built into them that could be opened, the same technology has not made its way in a significant manner to the panel construction industry.

In addition to using their garages to store automobiles, yard equipment and the like, many homeowners use their garages as a temporary home for pets. Since the pets often have to share the garage with the aforementioned smelly and toxic items, it would be advantageous to improve the air circulation in a garage. While it would be relatively easy to build in some opening windows into a monolithic garage door, it is more difficult trying to fit an efficient “vent” into a single panel.

Even if a venting panel were to be successfully integrated into a panel, no pet owner would want his or her pet to escape from the garage through the vent—hence, there would need to be means of allowing air, but not the pet, to escape the garage. Thus, has been created a long-felt need for a window that can be installed—either during the construction or as a retrofit—into a panel that allows for both air ventilation and pet confinement.

It is commonly known that there are many garage door manufacturers that manufacture several different garage door styles. Many of styles, from the various manufactures, have different window, or vent, opening dimensions. Typically each garage door manufacturer has premade window, or vent, frames that are four sided and rigid in nature and produced to fit only the window, or vent, opening that is cut into the garage door panels and that fits that particular size. These variations in the window, or vent, design dimensions create the need for dozens of different window frame dimensions requiring dozens of different plastic injection molds, requiring a huge expense, and making it difficult to create a standardized window frame size.

The current invention provides just such a solution by having a concept of duel customized frame and brace assemblies, which are designed to create a method allowing various window, or vent, design dimensions to be produced from a limited number of plastic injection molds. They would be used in conjunction with my previously submitted patent for a sliding windows or sliding pet viewing doors into a garage door. They may also be used in place of any standard garage door frame that is customarily of a fixed and rigid design if the manufacturer of the garage door should choose to use this design instead.

The first type of frame assembly, using Frame and Brace Style A, would be primarily, but not necessarily, used for premarket windows and vents placed in the garage door by the manufacturer of the garage door. Using Exterior and Interior Frames Style A in conjunction with the Exterior and Interior Corner Braces Style A would allow manufacturers to produce and install the proper sized windows, or vents, directly into the garage door prior to, or at the time, of sale to the consumer. This concept creates the ability for the main frame parts to be produced in two, three, four, or more feet in length that can then be cut down to appropriate length and joined together by a customized fitted corner brace. Each frame length produced can be cut into more than one frame size thus saving on production costs and mold costs. However, once installed these windows or vents would be of a fixed shape and size, as most window and vents are.

The use of Exterior and Interior Frames Style B in conjunction with the Exterior and Interior Corner Braces Style B allow for an adjustable frame design fitting multiple sized windows or vents. This type of design would be ideal for the aftermarket instillation for the consumer that already has a garage door in place with the window or vent openings already precut into the garage door. This design would allow for each frame to be manufactured fitting these various sized openings. It would allow for the frame to be adjusted up to several inches in width and/or length thus making available to the consumer the option of instillation, by themselves, for the addition of a sliding window or sliding pet viewing door. It is noted that in order to fit all possible precut window sizes this concept may be needed to be marketed in several different adjustable sizes of several inches each. This would be similar to a small, medium, or large marketing concepts used for other products or similar to men's clothing sizes with waist bands that fit 30-34, 34-38, 38-42, etc.

It is noted that once the desired size is acquired the frame would be secured in a stationary position and secured snuggly against the garage door panel and connected to the Interior Frame that has also been adjusted accordingly.

It is noted that for proper instillation each garage window, or vent, design requires two types of frames. First is an exterior frame which is placed on the exterior side of a garage door panel and is typically visible when viewing the exterior of the home, or building. It is usually more ornate than the interior frame. The second frame would be the interior frame placed on the interior side of the of the garage door panel. The exterior and interior frames would be of different construction styles. They would be placed adjacent to one another and secured together, against the garage door panel, using a securing device such as screws, nut and bolts, wing nuts, glue, tape, or by other means. In most current garage window, or vent, designs the frame consists of four sides, similar to a picture frame. My concept, particularly with respect to the interior frame, may consist of only two or three sides, when used as part of the design concept of the Sliding Window and/or Sliding Door assembly that has been previously submitted for patent protection.

### OBJECTS OF THE INVENTION

It is therefore an object of the present invention to provide a window that can be built into a garage door.

An additional object of the invention includes providing a window that can be installed into an existing garage door.

Another object of the invention is to provide a sliding mechanism by which the garage door window can be opened and closed easily.

A further object of the invention is to provide bars on the window to prevent pets from escaping through the garage door window.

Another object of the invention is to provide an easily-installed garage door window.

A final object of the invention is to provide for multiple windows to be inserted into a single panel of a garage door.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings. It is noted that the following figures are not drawn to scale.

FIG. 1 depicts one potential custom design for the Exterior Frame. It is constructed to allow a custom designed Corner Brace to be fitted into the side which would than allow for an additional frame side to be added. This view is for the outer side of the exterior frame.

FIG. 2 is a view of the backside, (interior side), of the Exterior Frame. It shows how this back side would have screw ports placed at regular intervals along the frames back. Because of the manufacturing needs of a typical plastic injection mold design these screw port holes would be connected by, and part of, a continuous raised support portion of the frame itself. These screw ports would be placed at the same intervals as the screw holes of the Interior Frame thus allowing, when cut down to matching size, the two frames to be fitted together in a snug configuration against the garage door panel which would be situated between the two frames

FIG. 3 is a side view, of one potential Exterior Frame design. It shows the corner brace openings and the screw port holes and raised support portion of the back of the frame.

FIG. 4 is a view of the Exterior Frame Corner Brace Style A. Its unique design permits it to be fitted into the corresponding openings in the sides of the exterior frame. It's unique design also allows for it to be fitted into the frame while, at the same time, permitting it to slide, unobstructed, past the screw port holes and raised support portion of the frame which runs the entire length of the frame.

FIG. 5 shows a front and back view of the Exterior Corner Brace Style A inserted into the Exterior Frame.

FIG. 6 shows the Corner Brace inserted into two sides of the Exterior Frame.

FIG. 7 shows a front view of the Interior Frame.

FIG. 8 shows a side view of the Interior Frame.

FIG. 9 shows the Interior Frame Corner Brace Style A.

FIG. 10 shows the position of the Interior Frame and the Interior Frame Corner Brace Style A. The Interior Corner Brace Style A would be INSERTED into the Interior Frame.

FIG. 11 shows the position of two Frame sections joined together by a Corner Brace Style A.

FIG. 12 shows the Interior Frame in relationship to the Interior Corner Brace Style B.

FIG. 13 shows the Interior Frame joined together by Corner Brace style B. Corner Brace Style B differs from Corner Brace Style A in that with Style B the Interior Frame is inserted into the Corner Brace whereas with Corner Brace Style A the brace is inserted into the Frame. The difference of the braces to be used would depend on the type and size (width) of garage door panel.

FIG. 14 shows the Interior Frame Corner Plug.

FIG. 15 shows the relative position of the Corner Plug and the Interior Frame. The Corner Plug would be used in instances were a full four sided Interior Frame would not be used and, therefore, an Interior Corner Brace would not be needed. Depending upon the type, size, and location, in the garage door panel, of the window, or vent, opening a full frame may not be needed.

FIG. 16 is a top view showing the relative positions of the Exterior and Interior Frame parts.

FIG. 17 is a side view showing the relative positions of the Exterior and Interior Frame parts.

FIG. 18 shows a four sided Interior Frame joined together by four Corner Style A Braces.

FIG. 19 is a view of a four sided Exterior Frame Style A braces joined together by four Exterior Corner Braces.

FIG. 20 is a rendition of this modular Interior Frame and Corner Brace Style A assembly as it might be used in conjunction with the Sliding Window Concept. In this view the Interior Frame is a four-sided frame configuration with four Corner Braces Style A being used.

FIG. 21 is a view of the modular Interior Frame used in conjunction with a Sliding Door Concept. In this view the Interior Frame has only two sides. Therefore, two Interior Frame End Caps are used.

FIG. 22 is a view of the Exterior Frame Style A braces assembled together by four Exterior Corner Braces.

FIG. 23 is a view of a garage door with two upper Sliding Windows and two lower Sliding Doors. This is a good example of the need for this modular frame and corner brace system. It shows the need for various lengths of frames. Two different lengths for the upper frame and at least one additional sized length for the lower frame. With the various garage door manufacturers and their various sized window openings many more sizes/lengths of frame would be needed.

FIG. 24 is an interior view of the relative positions of the Exterior Frame to the Exterior Frame Braces Style A. In this view two different lengths of frames are joined together by four Exterior Frame Braces. It is noted that in this view it is shown how the unique, custom made, Corner Braces would be able to connect the custom made frame pieces, while at the same time, slide, unobstructed, past the Screw Port Holes and the interior plastic connections needed for the proper plastic mold designs and production of the frame. It is also noted that in this figure the two, upper and lower, right Corner Braces are completely visible and the upper and lower left braces are partially visible. In actuality, when fitted together the portion of the braces that are fitted into the frame would not be visible at all, as shown in the left side portion of the frame. They would be encompassed in the frame itself.

FIG. 25 is a view of the relative position of the Exterior Frame Style B to the Exterior Corner Brace Style B. The extended portion of the Frame would slide INTO and OUT OF the Corner Brace, whereas, the shortened portion of the Frame would slide BACK and FORTH UNDER the extended portion of the Corner Brace. This alignment permits the frame size, width and/or length, to be adjusted from smaller to larger. The shortened portion of the frame would act as a cover to fill the gap created between the frame and the guide rails when an adjustment is needed for a larger window opening. It is noted that once the desired size is acquired the frame would be secured in a stationary position and secured snuggly against the garage door panel and connected to the Interior Frame that has also been adjusted accordingly.

FIG. 26 is similar to Figure but is a view of the relative positions of the four-sided frame and corner braces verses only two sided shown in FIG. 25. The extended portion of the Frame would slide INTO and OUT OF the Corner Brace, whereas, the shortened portion of the Frame would slide BACK and FORTH UNDER the extended portion of the Corner Brace. This alignment permits the frame size, width and/or length, to be adjusted from smaller to larger. The shortened portion of the frame would act as a cover to fill the gap created between the frame and the guide rails when an adjustment is needed for a larger window opening. It is noted that once the desired size is acquired the frame would be secured in a stationary position and secured snuggly against the garage door panel and connected to the Interior Frame that has also been adjusted accordingly.

It is also noted that when the Exterior and Interior Frames are adjusted to the proper fit to the window opening size the Exterior and Interior Corner Braces would also be secured together, against the garage door panel, using a screw, nut and bolt assembly, or by other means.

FIG. 27 is a view of the Frames Style B and Corner Brace Style B joined together.

FIG. 28 is a side view of a conceptual design for the Exterior Frame Style B and the Exterior Corner Brace Style B. The combined view, on the right, shows how the extended portion of the frame, (refer to FIGS. 25 and 26), would slide into the corner brace.

FIG. 29 is a view of the sliding window concept and how the Interior Frame Style B would be adjusted to conform to the adjusted size of the Exterior Frame. In this view the UPPER Guide Rail is secured against the UPPER Interior Frame, whereas, the LOWER Frame is moved slightly farther out, away from Guide Rail, with the use of the Sliding Extension Brackets, to allow for the larger size window opening. In reality it would be recommended that the upper and lower Interior Frame be moved at equal distances from the Guide Rail to allow for a more uniformed visual look from the exterior. Moving both Frames at equal distances form the Guide Rail also allows for greater adjustments in window size openings.

FIG. 30 is a view of the Interior side of the Exterior Frame Style B with the Screw Port Holes on the extended portion of the frame and the insulation strip on the shortened portion of the frame. As mentioned in previous Figure descriptions the extended portion would slide into the Exterior Frame Style B and the shortened portion would slide under the Frame and would help cover the gap between the Frame and Guide Rails when the Frame size is adjusted.

FIG. 31 is a side view of a Double Slotted Guide Rail. This is a revised construction type from the single slotted Guide Rail originally submitted in the Sliding Window and Sliding Door concept previously filed for patent protection. With this construction style the Sliding Window and Decorative Front Cover is housed between the upper and lower Guide Rails instead of in front of them (situated directly against the exterior frame). With this modification it allows for the Interior and Exterior Frames to be adjusted to fit the various window sizes without having to change the size of the windows or decorative front cover.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

Frame Summary

It is commonly known that there are many garage door manufacturers that manufacture several different garage door styles. Many of styles, from the various manufactures, have different window, or vent, opening dimensions. Typically each garage door manufacturer has premade window, or vent, frames that are four sided and rigid in nature and produced to fit only the window, or vent, opening that is cut into the garage door panels and that fits that particular size. These variations in the window, or vent, design dimensions create the need for dozens of different window frame dimensions requiring dozens of different plastic injection molds, requiring a huge expense, and making it difficult to create a standardized window frame size.

This concept, of a customized frame and brace assembly, is designed to create a method allowing various window, or vent, design dimensions to be produced from a limited number of plastic injection molds. The concept creates the ability for the main frame parts to be produced in two, three, four, or more feet in length that can then be cut down to appropriate length and joined together by a customized fitted corner brace. Each frame length produced can be cut into more than one frame size thus saving on production costs and mold costs.

It is noted that for proper instillation each garage window, or vent, design requires two types of frames. First is an exterior frame which is placed on the exterior side of a garage door panel and is typically visible when viewing the exterior of the home, or building. It is usually more ornate than the interior frame. The second frame would be the interior frame placed on the interior side of the of the garage door panel. The exterior and interior frames would be of different construction styles. They would be placed adjacent to one another and secured together, against the garage door panel, using a securing device such as screws, nut and bolts, glue, tape, or by other means. In most current garage window, or vent, designs the frame consists of four sides, similar to a picture frame. This concept, particularly with respect to the interior frame, may consist of only two or three sides, when used as part of the design concept of the Sliding Window and/or Sliding Door assembly that has been previously submitted for patent protection.

It is noted that the following figures are not drawn to scale.

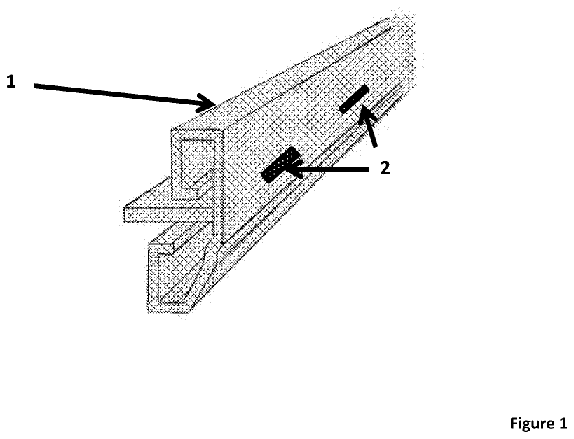

FIG. 1 depicts one potential custom design for the Exterior Frame 1 with weep holes 2 that allow water to flow out of the window. It is constructed to allow a custom designed Corner Brace to be fitted into the side which would than allow for an additional frame side to be added. This view is for the outer side of the exterior frame.

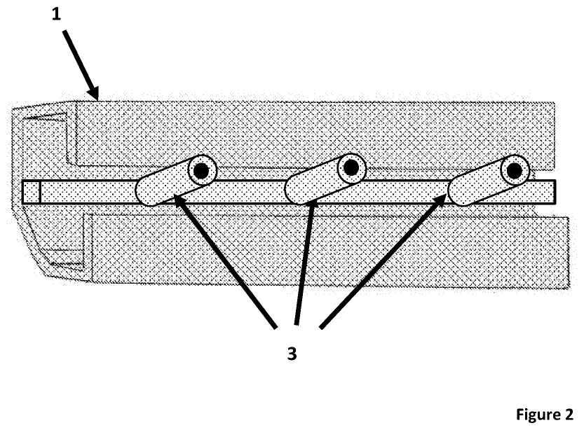

FIG. 2 is a view of the backside, (interior side), of the Exterior Frame 1. It shows how this back side would have screw ports 3 placed at regular intervals along the frames back. Because of the manufacturing needs of a typical plastic injection mold design these screw port holes would be connected by, and part of, a continuous raised support portion of the frame itself. These screw ports would be placed at the same intervals as the screw holes of the Interior Frame thus allowing, when cut down to matching size, the two frames to be fitted together in a snug configuration against the garage door panel which would be situated between the two frames

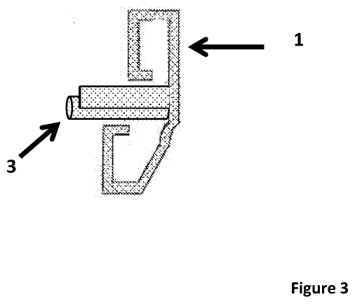

FIG. 3 is a side view, of one potential Exterior Frame 1 design. It shows the corner brace openings and the screw port holes 3 and raised support portion of the back of the frame.

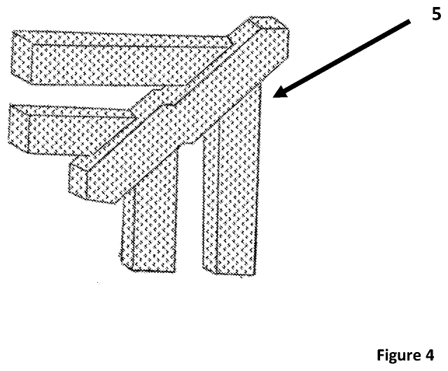

FIG. 4 is a view of the Exterior Frame Corner Brace Style A. Its unique design permits it to be fitted into the corresponding openings in the sides of the exterior frame. It's unique design also allows for it to be fitted into the frame while, at the same time, permitting it to slide, unobstructed, past the screw port holes and raised support portion of the frame which runs the entire length of the frame.

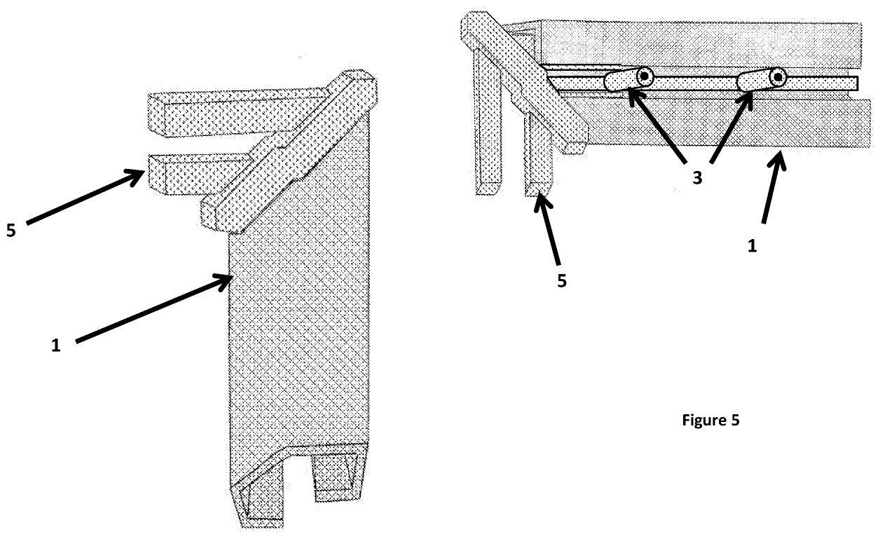

FIG. 5 shows a front and back view of the Exterior Corner Brace 5 inserted into the Exterior Frame 1.

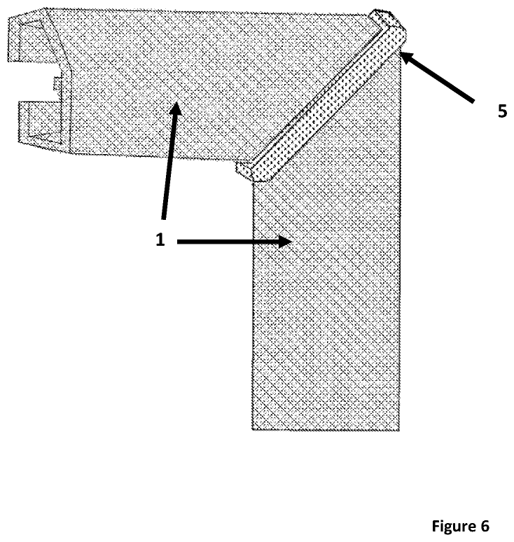

FIG. 6 shows the Corner Brace 5 inserted into two sides of the Exterior Frame

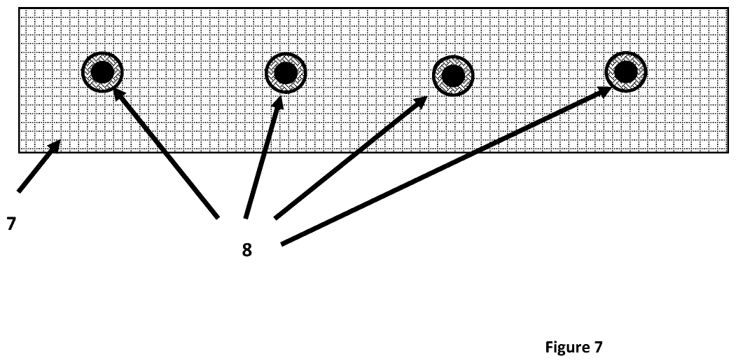

FIG. 7 shows a front view of the Interior Frame 7, with screw holes 8.

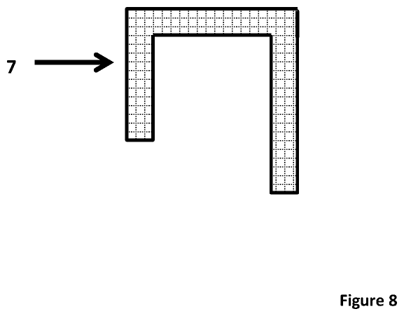

FIG. 8 shows a side view of the Interior Frame 7.

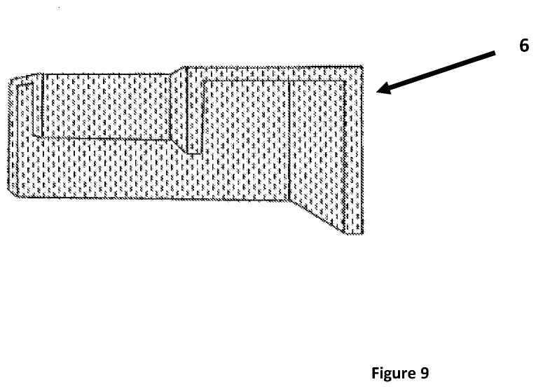

FIG. 9 shows the Interior Frame Corner Brace Style A 6.

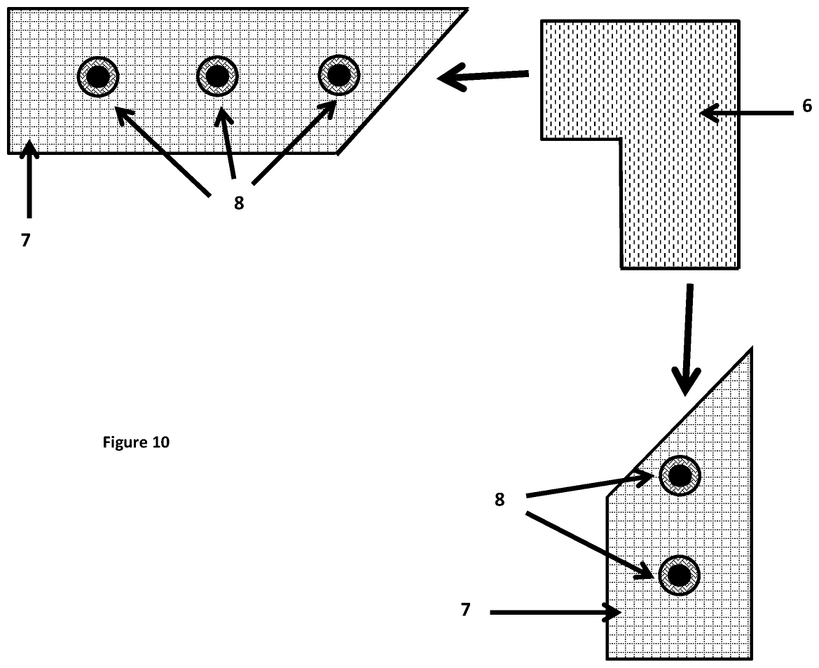

FIG. 10 shows the position of the Interior Frame 7 and the Interior Frame Corner Brace Style A 6. The Interior Corner Brace Style A 6 would be INSERTED into the Interior Frame 7.

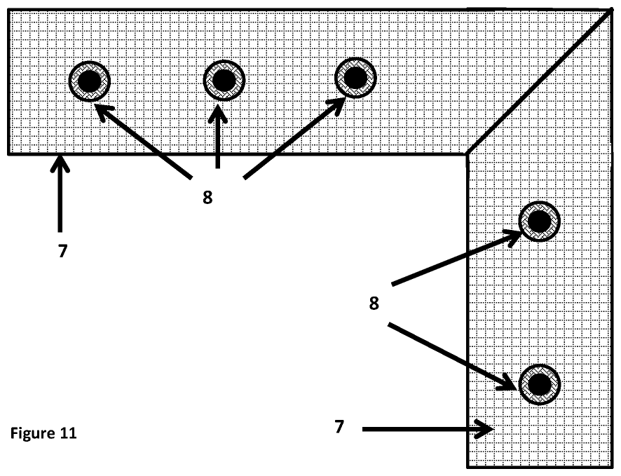

FIG. 11 shows the position of two Frame sections 7 joined together by a Corner Brace Style A (not visible in this drawing as the Corner Brace Style A is obscured under the two Frame sections 7.

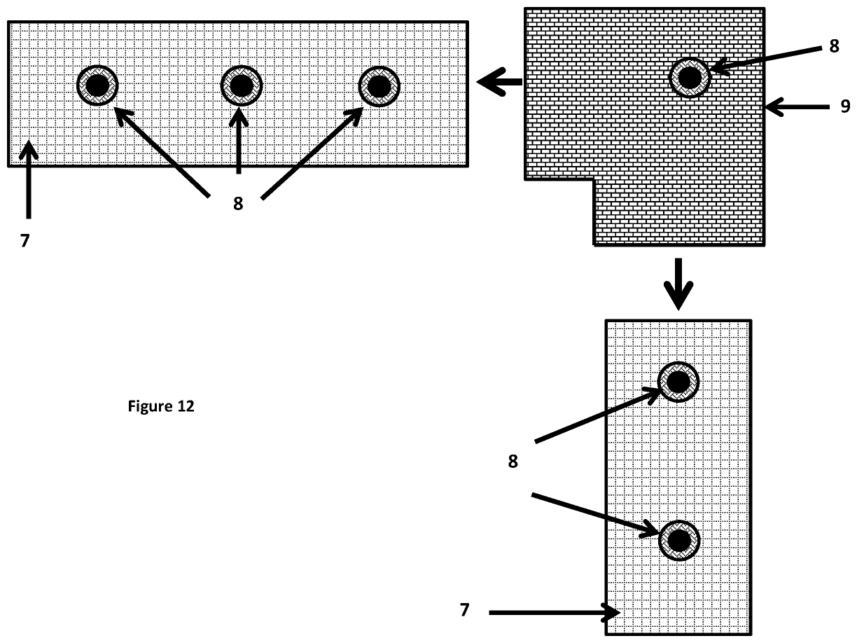

FIG. 12 shows the Interior Frame in relationship to the Interior Corner Brace Style B.

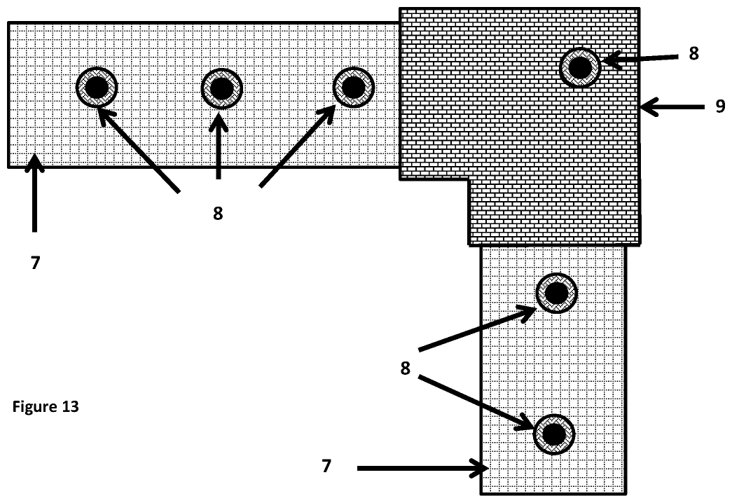

FIG. 13 shows the Interior Frame 7 joined together by Corner Brace style B 9. Corner Brace Style B differs from Corner Brace Style A in that with Style B the Interior Frame is inserted into the Corner Brace whereas with Corner Brace Style A the brace is inserted into the Frame. The difference of the braces to be used would depend on the type and size (width) of garage door panel.

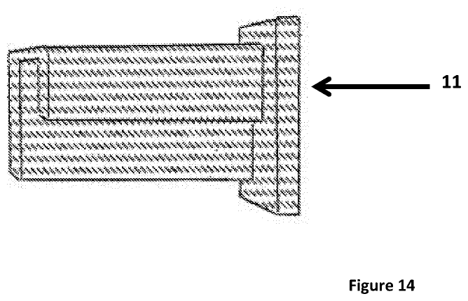

FIG. 14 shows the Interior Frame Corner Plug 11.

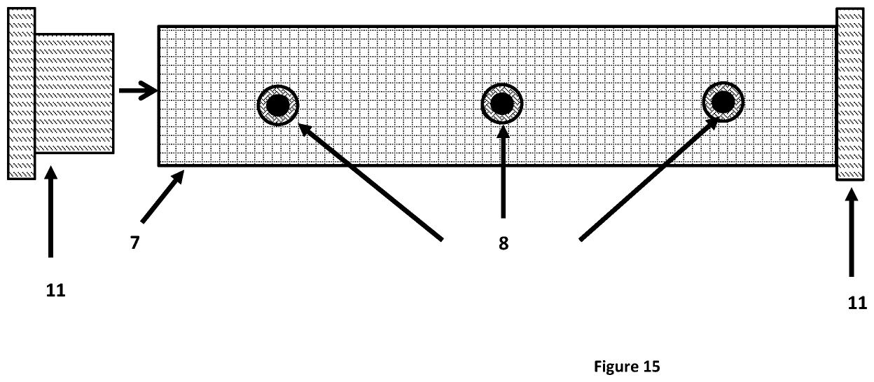

FIG. 15 shows the relative position of the Corner Plug 11 and the Interior Frame 7. The Corner Plug would be used in instances were a full four-sided Interior Frame would not be used and, therefore, an Interior Corner Brace would not be needed. Depending upon the type, size, and location, in the garage door panel, of the window, or vent, opening a full frame may not be needed.

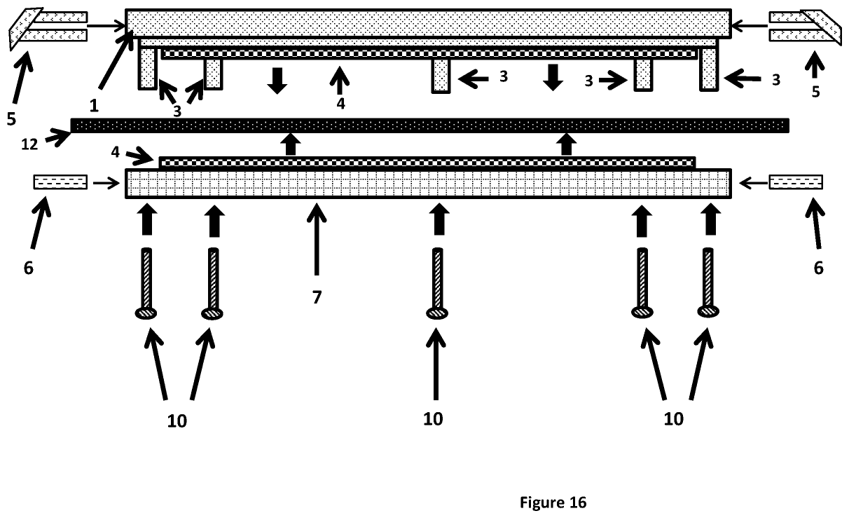

FIG. 16 is a top view showing the relative positions of the Exterior and Interior Frame parts. The Exterior Frame Style A 1 as screw ports 3 to which screws 10 from the Interior Side 7 protrude to secure the exterior frame to the interior frame, sandwiching a layer of insulation 4 and clamping over the edges of the garage door panel 12. Exterior Frame Corner Braces A 5 are inserted into the open ends of Exterior Frame Style A 1, and will be used to create a square or rectangular garage door window. On the interior side, Interior Corner Brace Style A 6 are used to connect the four parts of the interior frame together.

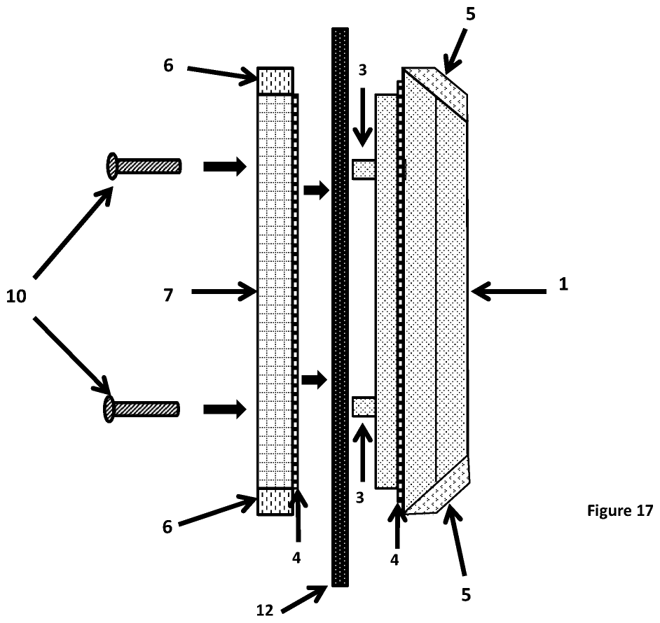

FIG. 17 is a side view showing the relative positions of the Exterior 1 and Interior Frame 7 parts. Screws 10 pass through holes in the Interior Frame 7 and screw into screw ports 3 in the Exterior Frame 1. Exterior Corner Braces A 5 serve to connect the four parts of the Exterior Frame 1. Interior Corner Braces 6 server to connect the four parts of the Interior Frame 7. The Exterior Frame 1 and Interior Frame are screwed toward each other, thereby clamping the edges of the Garage Door Panel 12.

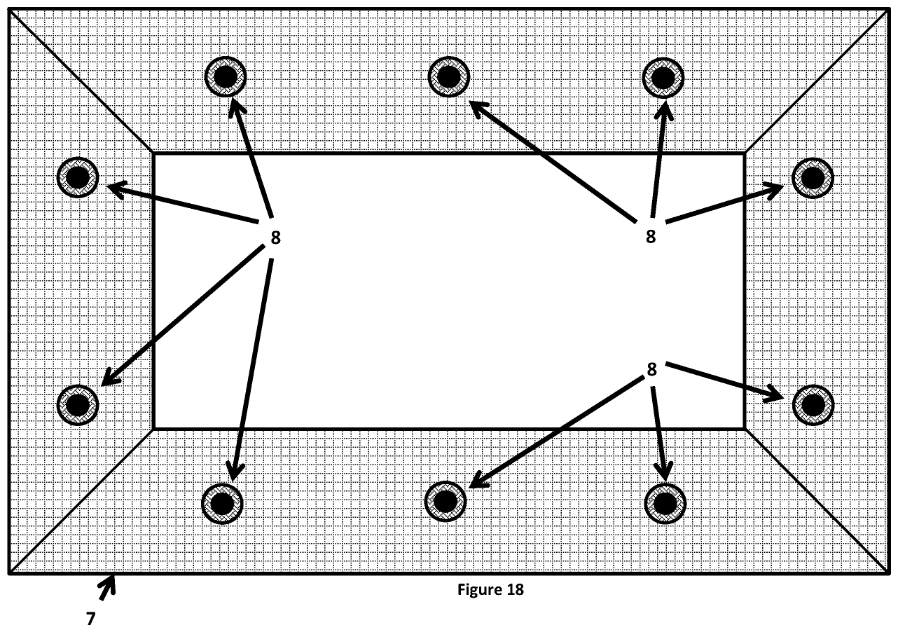

FIG. 18 shows a four-sided Interior Frame 7 joined together by four Corner Style A Braces (not visible).

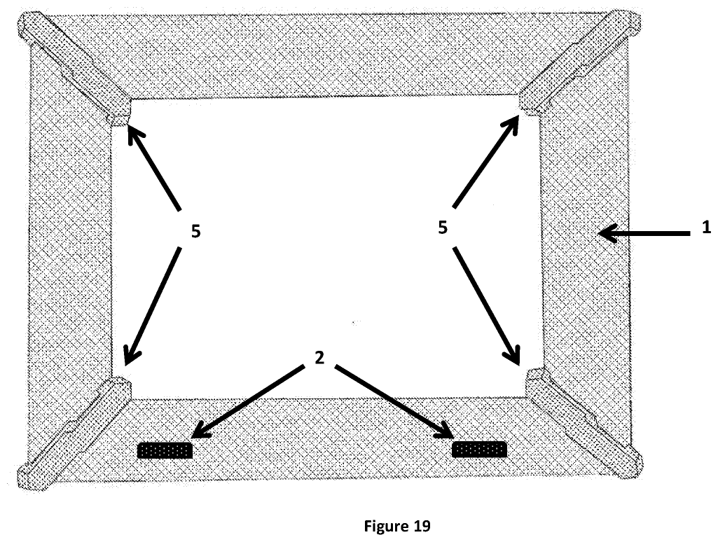

FIG. 19 is a view of a four-sided Exterior Frame 1 joined together by four Exterior Corner Braces 5. The weep holes are also visible in this figure.

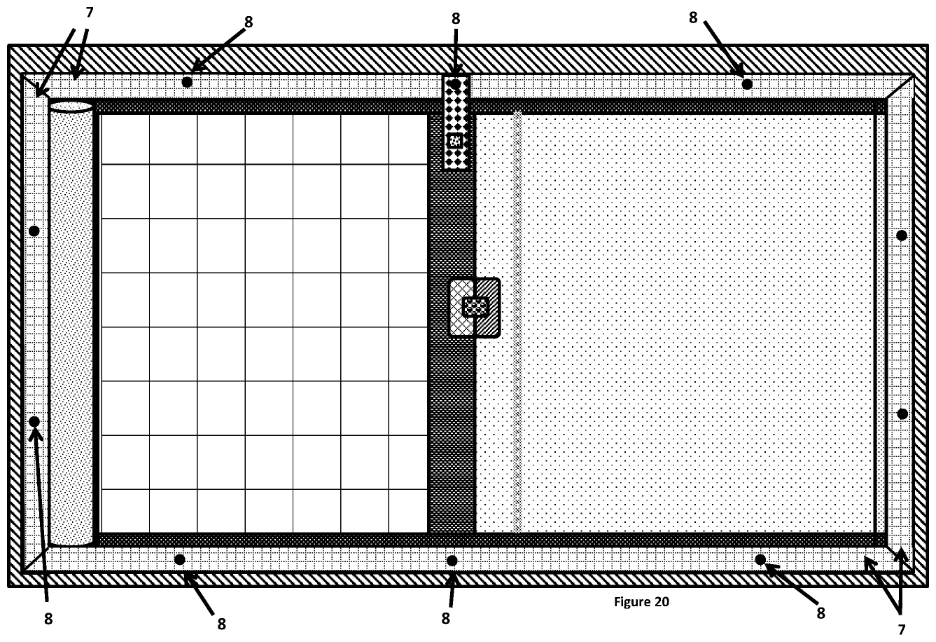

FIG. 20 is a rendition of this modular Interior Frame and Corner Brace Style A assembly as it might be used in conjunction with the Sliding Window Concept. In this view the Interior Frame 7 is a four-sided frame configuration with four Corner Braces Style A (not visible) being used.

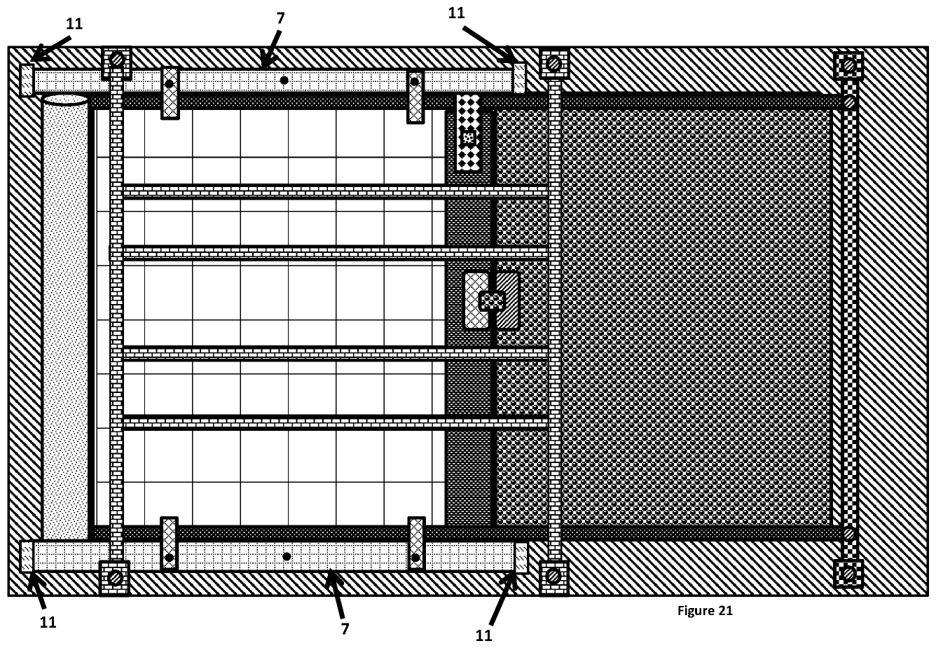

FIG. 21 is a view of the modular Interior Frame used in conjunction with a Sliding Door Concept. In this view the Interior Frame 7 has only two sides. Therefore, two Interior Frame End Caps 11 are used.

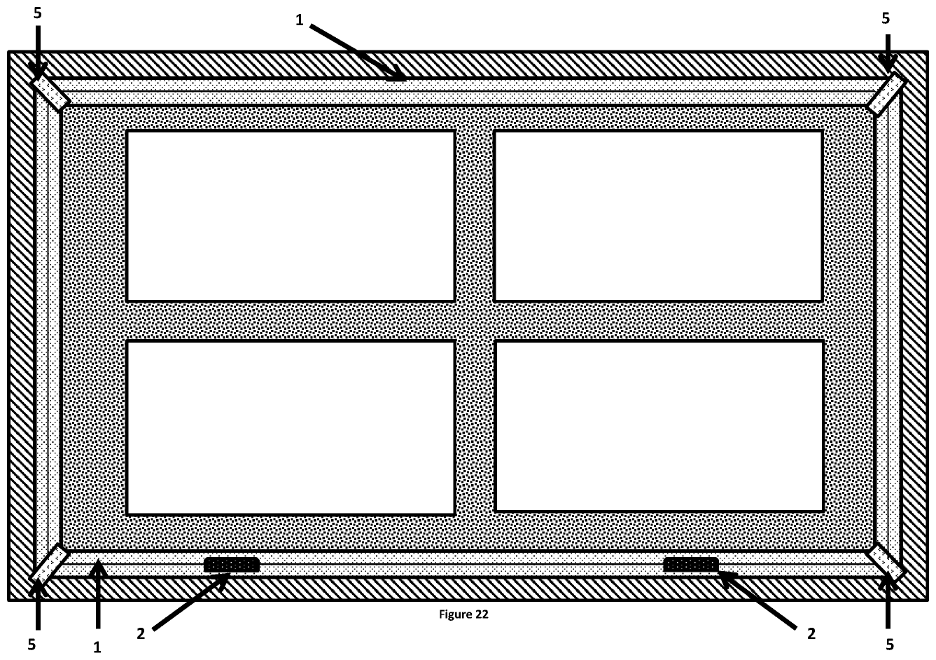

FIG. 22 is a view of the Exterior Frame 1 assembled together by four Exterior Corner Braces 5.

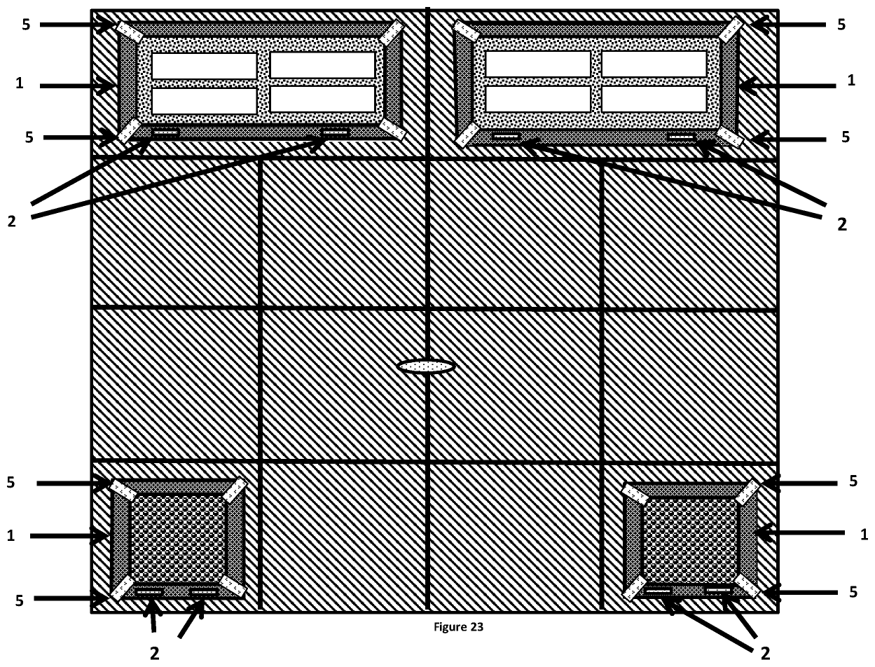

FIG. 23 is a view of a garage door with two upper Sliding Windows and two lower Sliding Doors, with the exterior frames 1 being held together with Exterior Frame Corner Braces A 5. This is a good example of the need for this modular frame and corner brace system. It shows the need for various lengths of frames. Two different lengths for the upper frame and at least one additional sized length for the lower frame. With the various garage door manufacturers and their various sized window openings many more sizes/lengths of frame would be needed.

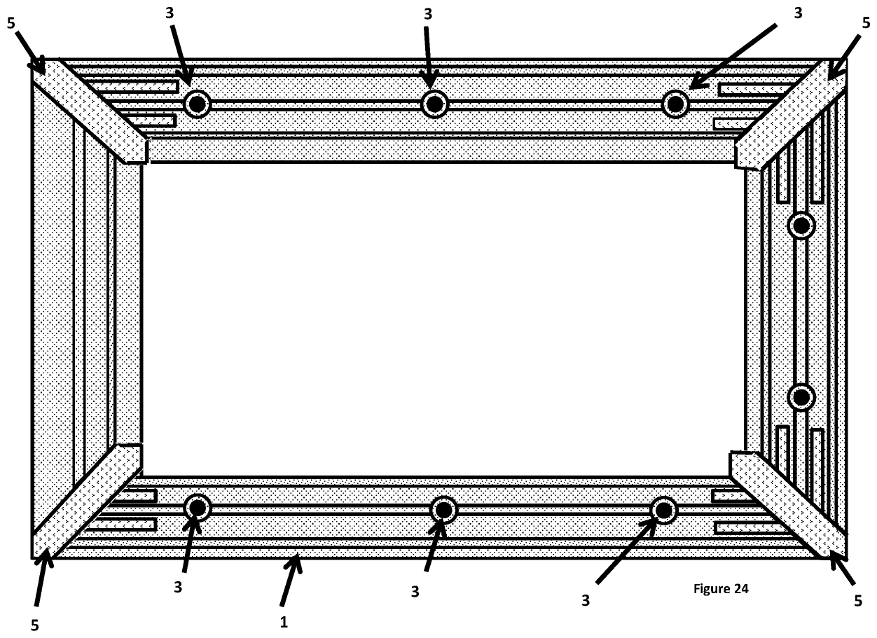

FIG. 24 is an interior view of the relative positions of the Exterior Frame 1 to the Exterior Frame Braces Style A 5. In this view two different lengths of frames are joined together by four Exterior Frame Braces. It is noted that in this view it is shown how the unique, custom made, Corner Braces would be able to connect the custom made frame pieces, while at the same time, slide, unobstructed, past the Screw Port Holes 3 and the interior plastic connections needed for the proper plastic mold designs and production of the frame. It is also noted that in this figure the two, upper and lower, right Corner Braces are completely visible and the upper and lower left braces are partially visible. In actuality, when fitted together the portion of the braces that are fitted into the frame would not be visible at all, as shown in the left side portion of the frame. They would be encompassed in the frame itself.

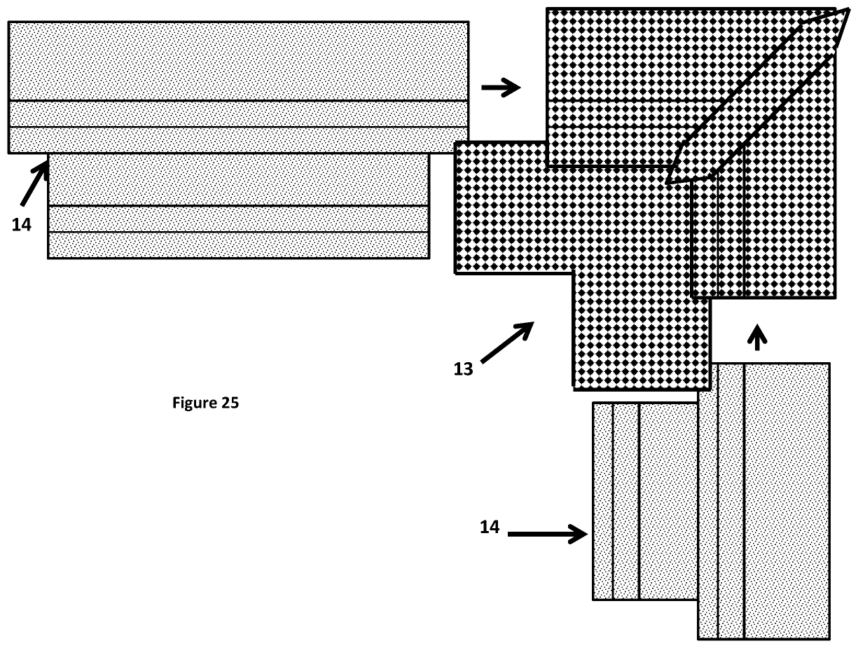

FIG. 25 is a view of the relative position of the Exterior Frame Style B 14 to the Exterior Corner Brace Style B 13. The extended portion of the Frame would slide INTO and OUT OF the Corner Brace, whereas, the shortened portion of the Frame would slide BACK and FORTH UNDER the extended portion of the Corner Brace. This alignment permits the frame size, width and/or length, to be adjusted from smaller to larger. The shortened portion of the frame would act as a cover to fill the gap created between the frame and the guide rails when an adjustment is needed for a larger window opening. It is noted that once the desired size is acquired the frame would be secured in a stationary position and secured snuggly against the garage door panel and connected to the Interior Frame that has also been adjusted accordingly.

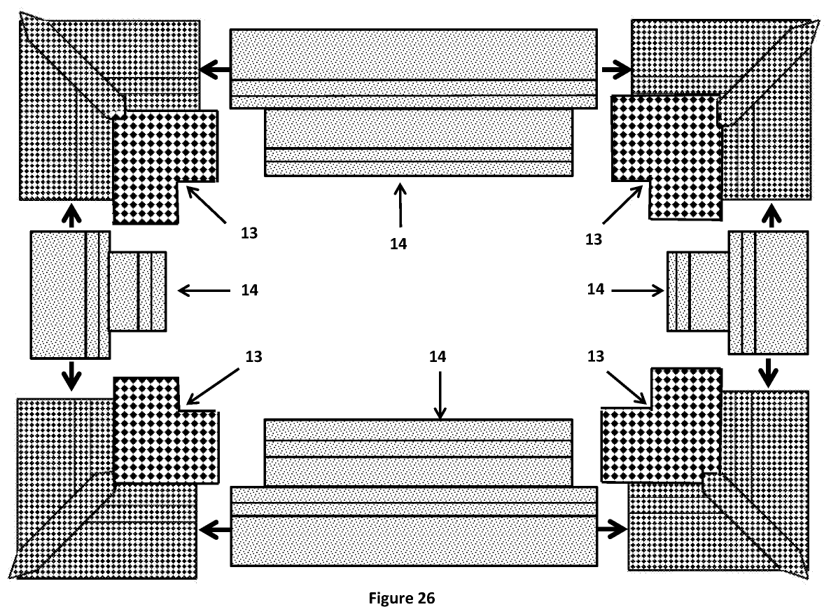

FIG. 26 is similar to Figure but is a view of the relative positions of the four-sided frame 14 and corner braces 13 verses only two sided shown in FIG. 25. The extended portion of the Frame would slide INTO and OUT OF the Corner Brace, whereas, the shortened portion of the Frame would slide BACK and FORTH UNDER the extended portion of the Corner Brace. This alignment permits the frame size, width and/or length, to be adjusted from smaller to larger. The shortened portion of the frame would act as a cover to fill the gap created between the frame and the guide rails when an adjustment is needed for a larger window opening. It is noted that once the desired size is acquired the frame would be secured in a stationary position and secured snuggly against the garage door panel and connected to the Interior Frame that has also been adjusted accordingly.

It is also noted that when the Exterior and Interior Frames are adjusted to the proper fit to the window opening size the Exterior and Interior Corner Braces would also be secured together, against the garage door panel, using a screw, nut and bolt assembly, or by other means.

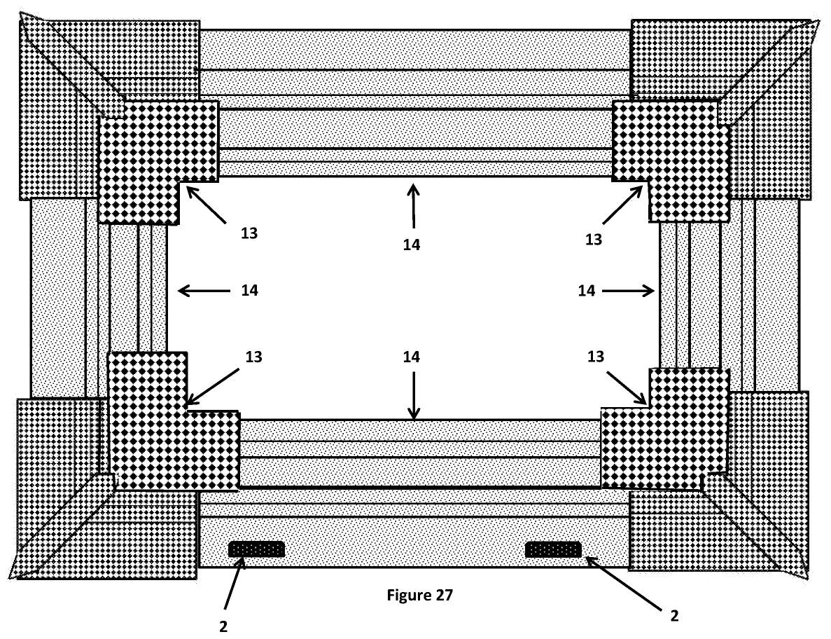

FIG. 27 is a view of the Frames Style B and Corner Brace Style B joined together.

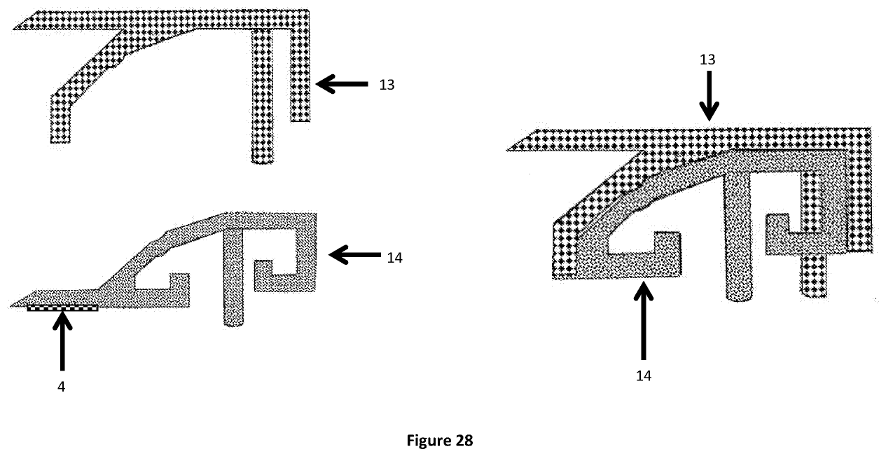

FIG. 28 is a side view of a conceptual design for the Exterior Frame Style B 14 and the Exterior Corner Brace Style B 13. The combined view, on the right, shows how the extended portion of the frame, (refer to FIGS. 25 and 26), would slide into the corner brace.

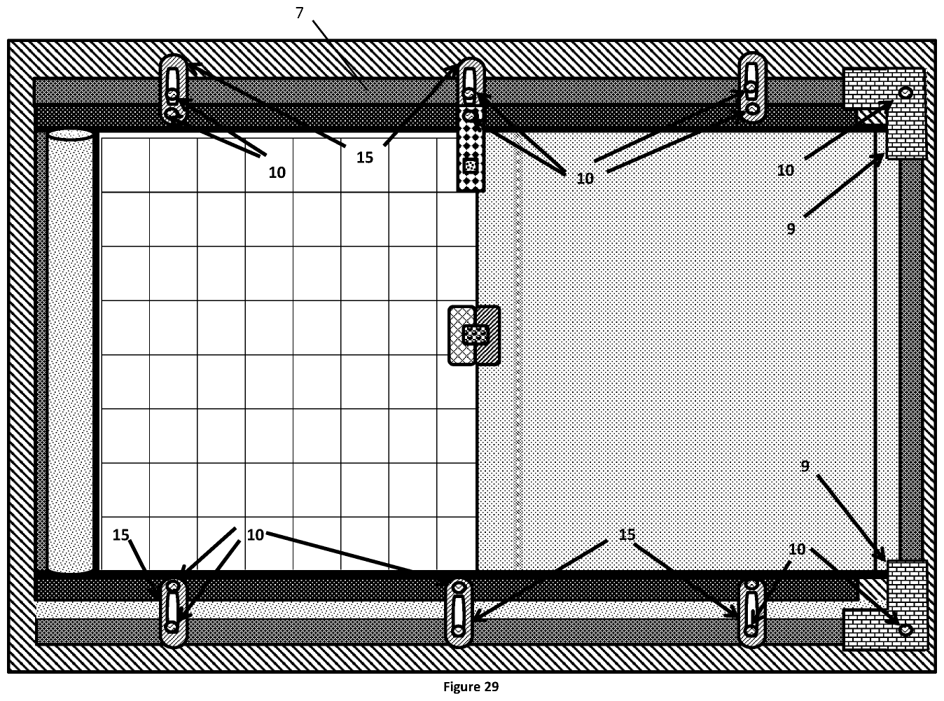

FIG. 29 is a view of the sliding window concept and how the Interior Frame Style B would be adjusted to conform to the adjusted size of the Exterior Frame. In this view the UPPER Guide Rail is secured against the UPPER Interior Frame, whereas, the LOWER Frame is moved slightly farther out, away from Guide Rail, with the use of the Sliding Extension Brackets 15, to allow for the larger size window opening. In reality it would be recommended that the upper and lower Interior Frame be moved at equal distances from the Guide Rail to allow for a more uniformed visual look from the exterior. Moving both Frames at equal distances form the Guide Rail also allows for greater adjustments in window size openings.

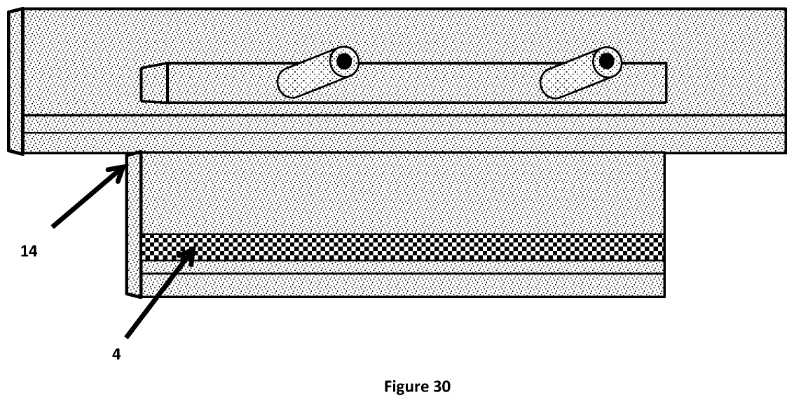

FIG. 30 is a view of the Interior side of the Exterior Frame Style B with the Screw Port Holes on the extended portion of the frame and the insulation strip 4 on the shortened portion of the frame. As mentioned in previous Figure descriptions the extended portion would slide into the Exterior Frame Style B 14 and the shortened portion would slide under the Frame and would help cover the gap between the Frame and Guide Rails when the Frame size is adjusted. It should be noted that the screw port holes can be located on either the upper strip or the lower strip.

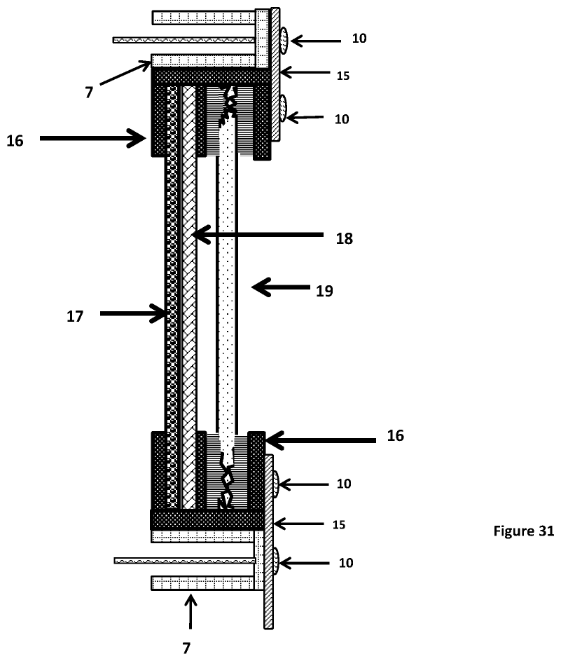

FIG. 31 is a side view of a Double Slotted Guide Rail. This is a revised construction type from the single slotted Guide Rail originally submitted in the Sliding Window and Sliding Door concept previously filed for patent protection. With this construction style the Sliding Window 19 and Decorative Front Cover 17 is housed between the upper and lower Guide Rails 16 instead of in front of them (situated directly against the exterior frame). With this modification it allows for the Interior 7 and Exterior Frames to be adjusted to fit the various window sizes without having to change the size of the windows or decorative front cover.

### GARAGE DOOR PANEL ITEM NUMBERS

### #1 Frame Item Numbers

#1 Exterior Frame Member Style A
#2 Weep Holes
#3 Screw Ports
#4 Insulation
#5 Exterior Frame Corner Brace A
#6 Interior Corner Brace Style A
#7 Interior Frame Member
#8 Screw Holes
#9 Interior Frame Corner Brace Style B
#10 Bolt or Screw or Wing Nut Frame Fastener
#11 Interior Frame End Cap
#12 Garage Door Panel
#13 Exterior Corner Frame Brace Style B
#14 Exterior Frame Member Style B
#15 Sliding Extension Brackets
#16 Duel Slotted Guide Rail
#17 Front Decorative Window Cover
#18 Stationary Window
#19 Sliding Window

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A window for a garage door panel, consisting of: a body, an opening, and an attachment device that attaches the body to a panel of a garage door, where the opening is located in the body, and bounded on all sides by the body, where the body comprises an exterior frame and an interior frame, where the interior frame comprises one or more screw holes, and where the exterior frame comprises one or more screw ports, where one or more screws, each with a screw head and a threaded portion, attach the interior frame to the exterior frame as the screw head rests on an outside face of the interior frame and the threaded portion mates with a screw port threaded portion, where the exterior frame comprises four exterior members and four exterior corner braces, where each of the four exterior corner braces joins two of the four exterior members at a 90 degree angle, and where the interior frame comprises four interior members and four interior corner braces, where each of the four interior corner braces joins two of the four interior members at a 90 degree angle, such that the interior frame and the exterior frame are tightened against each to clasp four edges of a cavity in a garage door panel.

2. The window of claim 1, additionally comprising one or more layers of insulation, with the one or more layers of insulation is located between an inner face of the interior frame and an interior face of the exterior frame.

3. The window of claim 2, where the exterior frame additionally comprises one or more weep holes.

4. A window for a garage door panel, comprising: a body, an opening, and an attachment device which attaches the body to a panel of a garage door, where the opening is located in the body, and bounded on all sides by the body, where the body comprises an exterior frame and an interior frame, where the interior frame comprises one or more screw holes, and where the exterior frame comprises one or more screw ports, where one or more screws, each with a screw head and a threaded portion, attach the interior frame to the exterior frame as the screw head rests on an outside face of the interior frame and the threaded portion mates with a screw port threaded portion, where the exterior frame comprises four exterior members and four exterior corner braces, where each of the four exterior corner braces joins two of the four exterior members at a 90 degree angle, and where the interior frame comprises two or more interior members and four or fewer interior corner braces, and two or fewer end caps, where each of the four or fewer interior corner braces joins two of the four interior members at a 90 degree angle, such that the interior frame and the exterior frame are tightened against each to clasp four edges of a cavity in a garage door panel.

5. The window of claim 4, where each of the four exterior corner braces comprises a central joiner and four inserts, where each of the four inserts protrudes from the central joiner at an approximately 45 degree angle, where two of the four inserts mate with two insert cavities in one of the exterior frame members, such that the exterior frame comprises four exterior members, each at a 90 degree angle to two adjacent exterior members, such that after connecting two exterior frame members with an exterior corner brace, only the central joiner of the exterior corner brace remains visible.

6. The window of claim 5, additionally comprising a sliding door cover, where the sliding door cover can be moved in a lateral direction across the body to cover and uncover the opening.

7. The window of claim 4, where each of the four exterior corner braces comprises an outer joiner and an inner joiner, where the outer joiner is connected to the inner joiner, and where the outer joiner has two outer joiner cavities set at a 90 angle to each other, and where the inner joiner has two inner joiner cavities set at a 90 angle to each other, and where each of the four exterior members comprises two exterior insert ends, and where each of the two exterior insert ends comprises two exterior inserts, where a first exterior insert nestles in the outer joiner cavity and a second exterior insert nestles in the inner joiner cavity, such that the exterior frame comprises four exterior members, each at a 90 degree angle to two adjacent exterior members, such that after connecting two exterior frame members with an exterior corner brace, both the outer joiner and the inner joiner remain visible.

8. The window of claim 7, where the opening additionally comprises one or more security bars.

9. The window of claim 4, where each of the interior corner braces comprises a 90 degree joiner with two joiner ends, where each of the two joiner ends extends from a central line at approximately a 90 degree angle, where each of the two joiner ends mate with a joiner cavity in one of the interior frame members, such that the interior frame comprises four interior members, each at a 90 degree angle to two adjacent interior members, such that after connecting two interior frame members with an interior corner brace, the interior corner brace is not visible.

10. The window of claim 9, additionally comprising one or more layers of insulation, with the one or more layers of insulation is located between an inner face of the interior frame and an interior face of the exterior frame.

11. The window of claim 4, where each of the interior corner braces comprises a 90 degree covering joiner with two covering joiner ends, where each of the two covering joiner ends extends from a central covering line at approximately a 90 degree angle, where each of the two covering joiner ends mate with an interior joiner cavity in one of the interior frame members, such that the interior frame comprises four interior members, each at a 90 degree angle to two adjacent interior members, such that after connecting two interior frame members with an interior corner brace, the interior corner brace is visible.

12. The window of claim 11, where the exterior frame additionally comprises one or more weep holes.

13. The window of claim 4, where each of the four exterior corner braces comprises a central joiner and four inserts, where each of the four inserts protrudes from the central joiner at an approximately 45 degree angle, where two of the four inserts mate with two insert cavities in one of the exterior frame members, such that the exterior frame comprises four exterior members, each at a 90 degree angle to two adjacent exterior members, such that after connecting two exterior frame members with an exterior corner brace, only the central joiner of the exterior corner brace remains visible, where each of the interior corner braces comprises a 90 degree joiner with two joiner ends, where each of the two joiner ends extends from a central line at approximately a 90 degree angle, and where each of the two joiner ends mate with a joiner cavity in one of the interior frame members, such that the interior frame comprises four interior members, each at a 90 degree angle to two adjacent interior members, such that after connecting two interior frame members with an interior corner brace, the interior corner brace is not visible.

14. The window of claim 13, additionally comprising a stationary panel and a sliding panel, where the stationary panel and the sliding panel are contained within the opening, additionally comprising a screen guide rail, where the sliding panel slides within the screen guide rail, where the sliding panel can be moved in a lateral direction across the body, additionally comprising a sliding door handle, where the sliding door handle is attached to the sliding door panel and allows a user to slide the sliding panel by applying a pressure to the sliding door handle.

15. The window of claim 4, where each of the four exterior corner braces comprises a central joiner and four inserts, where each of the four inserts protrudes from the central joiner at an approximately 45 degree angle, where two of the four inserts mate with two insert cavities in one of the exterior frame members, such that the exterior frame comprises four exterior members, each at a 90 degree angle to two adjacent exterior members, such that after connecting two exterior frame members with an exterior corner brace, only the central joiner of the exterior corner brace remains visible, where each of the interior corner braces comprises a 90 degree covering joiner with two covering joiner ends, where each of the two covering joiner ends extends from a central covering line at approximately a 90 degree angle, where each of the two covering joiner ends mate with an interior joiner cavity in one of the interior frame members, such that the interior frame comprises four interior members, each at a 90 degree angle to two adjacent interior members, such that after connecting two interior frame members with an interior corner brace, the interior corner brace is visible.

16. The window of claim 4, where each of the four exterior corner braces comprises an outer joiner and an inner joiner, where the outer joiner is connected to the inner joiner, and where the outer joiner has two outer joiner cavities set at a 90 angle to each other, and where the inner joiner has two inner joiner cavities set at a 90 angle to each other, and where each of the four exterior members comprises two exterior insert ends, and where each of the two exterior insert ends comprises two exterior inserts, where a first exterior insert nestles in the outer joiner cavity and a second exterior insert nestles in the inner joiner cavity, such that the exterior frame comprises four exterior members, each at a 90 degree angle to two adjacent exterior members, such that after connecting two exterior frame members with an exterior corner brace, both the outer joiner and the inner joiner remain visible, where each of the interior corner braces comprises a 90 degree joiner with two joiner ends, where each of the two joiner ends extends from a central line at approximately a 90 degree angle, where each of the two joiner ends mate with a joiner cavity in one of the interior frame members, such that the interior frame comprises four interior members, each at a 90 degree angle to two adjacent interior members, such that after connecting two interior frame members with an interior corner brace, the interior corner brace is not visible.

17. The window of claim 16, where the exterior frame additionally comprises one or more weep holes.

18. The window of claim 4, where each of the four exterior corner braces comprises an outer joiner and an inner joiner, where the outer joiner is connected to the inner joiner, and where the outer joiner has two outer joiner cavities set at a 90 angle to each other, and where the inner joiner has two inner joiner cavities set at a 90 angle to each other, and where each of the four exterior members comprises two exterior insert ends, and where each of the two exterior insert ends comprises two exterior inserts, where a first exterior insert nestles in the outer joiner cavity and a second exterior insert nestles in the inner joiner cavity, such that the exterior frame comprises four exterior members, each at a 90 degree angle to two adjacent exterior members, such that after connecting two exterior frame members with an exterior corner brace, both the outer joiner and the inner joiner remain visible, where each of the interior corner braces comprises a 90 degree covering joiner with two covering joiner ends, where each of the two covering joiner ends extends from a central covering line at approximately a 90 degree angle, where each of the two covering joiner ends mate with an interior joiner cavity in one of the interior frame members, such that the interior frame comprises four interior members, each at a 90 degree angle to two adjacent interior members, such that after connecting two interior frame members with an interior corner brace, the interior corner brace is visible.

19. The window of claim 18, where each of the four exterior corner braces consists of an outer joiner and an inner joiner, where the outer joiner is connected to the inner joiner, and where the outer joiner consists of two outer joiner cavities set at a 90 angle to each other, and where the inner joiner has two inner joiner cavities set at a 90 angle to each other, and where each of the four exterior members comprises two exterior insert ends, and where each of the two exterior insert ends comprises two exterior inserts, where a first exterior insert nestles in the outer joiner cavity and a second exterior insert nestles in the inner joiner cavity, such that the exterior frame comprises four exterior members, each at a 90 degree angle to two adjacent exterior members, such that after connecting two exterior frame members with an exterior corner brace, both the outer joiner and the inner joiner remain visible, where each of the interior corner braces comprises a 90 degree covering joiner with two covering joiner ends, where each of the two covering joiner ends extends from a central covering line at approximately a 90 degree angle, where each of the two covering joiner ends mate with an interior joiner cavity in one of the interior frame members, such that the interior frame comprises four interior members, each at a 90 degree angle to two adjacent interior members, such that after connecting two interior frame members with an interior corner brace, the interior corner brace is visible.

20. The window of claim 19, where the exterior frame additionally comprises one or more weep holes.
